(19) United States
(12) Patent Application Publication
(10) Pub. No.: US 2024/0312318 A1
(43) Pub. Date: Sep. 19, 2024

(54) CHECKOUT MACHINE, METHOD, AND SYSTEM

(71) Applicant: Toshiba Tec Kabushiki Kaisha, Tokyo (JP)

(72) Inventors: Hikaru KOMIYAMA, Yokohama Kanagawa (JP); Kanako NAKAHARA, Shinagawa Tokyo (JP)

(21) Appl. No.: 18/540,693

(22) Filed: Dec. 14, 2023

(30) Foreign Application Priority Data
Mar. 17, 2023 (JP) 2023-042936

(51) Int. Cl. G07G 1/14; G06Q 30/06

(52) U.S. Cl. CPC G07G 1/14; G06Q 30/06

(57) ABSTRACT

A checkout machine in a store for performing a checkout process in a sales transaction, includes a network interface connectable to a transaction management server for managing a sales transaction in which a checkout process is performed with or without a checkout machine in the store; and a processor configured to: acquire, from the transaction management server, data of a sales transaction in which a checkout process is performed without any checkout machine in the store, and a first transaction code of the sales transaction, the first transaction code being issued by the transaction management server according to a first code scheme, issue a second transaction code according to a second code scheme that is different from the first code scheme, and control the network interface to transmit the data of the sales transaction and the second transaction code to an electronic receipt server.

### CROSS-REFERENCE TO RELATED APPLICATION

This application is based upon and claims the benefit of priority from Japanese Patent Application No. 2023-042936, filed on Mar. 17, 2023, the entire contents of which are incorporated herein by reference.

### FIELD

Embodiments of the present disclosure relate generally to a checkout machine, a method, and a system.

### BACKGROUND

In stores such as supermarkets, systems are becoming popular in which customers register commodities for purchase while moving around in the stores. Such systems include a shopping cart system in which a terminal having a commodity registration function and the like is used and a self-scanning system in which a portable terminal owned by a customer, a portable terminal prepared in advance by a store, or the like is used.

In such systems, the customer can use various settlement methods. For example, the customer can choose not only a settlement using a checkout machine but also an online settlement using his or her portable terminal.

Electronic receipts are also becoming popular. It has been requested to link transaction data with an electronic receipt device irrespective of a settlement method. For example, if a customer performs an online settlement using his or her terminal not via a checkout machine, the customer cannot receive a paper receipt.

### BRIEF DESCRIPTION OF THE DRAWINGS

FIG. 1 is a block diagram illustrating an overview of a configuration of an information processing system according to an embodiment.

FIG. 2 is a block diagram illustrating an overview of a configuration of a transaction management server according to an embodiment.

FIG. 3 is a block diagram illustrating an overview of a configuration of an electronic receipt server according to an embodiment.

FIG. 4 is a block diagram illustrating an overview of a configuration of a first checkout machine according to an embodiment.

FIG. 5 is a block diagram illustrating an overview of a configuration of a second checkout machine according to an embodiment.

FIG. 6 is a diagram illustrating a transaction top screen displayed on a terminal according to an embodiment.

FIG. 7 is a diagram illustrating a personal authentication screen displayed on the terminal.

FIG. 8 is a diagram illustrating a linkage check screen displayed on the terminal.

FIG. 9 is a diagram illustrating an electronic receipt top screen displayed on the terminal.

FIG. 10 is a diagram illustrating a settlement selection screen displayed on the terminal.

FIG. 11 is a sequence chart of display processing for an electronic receipt in the information processing system.

FIG. 12A is a sequence chart of linkage processing for associating a shopping member ID and an electronic receipt member ID in the information processing system.

FIG. 12B is a sequence chart of the linkage processing for associating a shopping member ID and an electronic receipt member ID in the information processing system.

FIG. 13 is a sequence chart illustrating a first example of linkage processing for associating transaction data with the electronic receipt server in the information processing system.

FIG. 14 is a sequence chart of commodity return processing in the information processing system.

FIG. 15 is a sequence chart illustrating a second example of linkage processing for associating transaction data with the electronic receipt server in the information processing system.

FIG. 16A is a sequence chart illustrating a third example of linkage processing for associating transaction data with the electronic receipt server in the information processing system.

FIG. 16B is a sequence chart illustrating the third example of linkage processing for associating transaction data with the electronic receipt server in the information processing system.

FIG. 17 is a sequence chart illustrating another example of the commodity return processing in the information processing system.

### DETAILED DESCRIPTION

In general, embodiments of this disclosure provide a technique for linking transaction data with an electronic receipt device.

In one embodiment, a checkout machine in a store for performing a checkout process in a sales transaction, comprises: a network interface connectable to a transaction management server for managing a sales transaction in which a checkout process is performed with or without a checkout machine in the store and an electronic receipt server for managing an electronic receipt of the sales transaction; and a processor configured to: acquire, from the transaction management server, data of a sales transaction in which a checkout process is performed without any checkout machine in the store, and a first transaction code of the sales transaction, the first transaction code being issued by the transaction management server according to a first code scheme, issue a second transaction code according to a second code scheme that is different from the first code scheme, and control the network interface to transmit the data of the sales transaction and the second transaction code to the electronic receipt server.

Embodiments of this disclosure are explained below with reference to the drawings. Note that, in drawings used for the following explanation of the embodiments, dimensions of depicted components are sometimes changed as appropriate. In the drawings used for the following explanation of the embodiments, components are sometimes omitted for purposes of explanation.

### Configuration Example

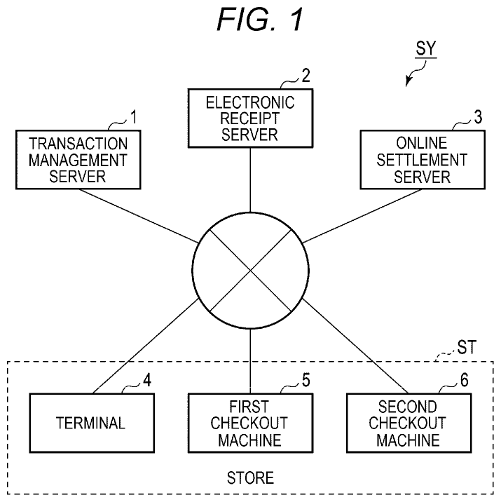

FIG. 1 is a block diagram illustrating an overview of a configuration of an information processing system SY.

The information processing system SY includes a transaction management server 1, an electronic receipt server 2, an online settlement server 3, a terminal 4, a first checkout machine 5, and a second checkout machine 6. The terminal 4, the first checkout machine 5, and the second checkout machine 6 are devices used in a store ST. The transaction management server 1, the electronic receipt server 2, the online settlement server 3, the terminal 4, the first checkout machine 5, and the second checkout machine 6 are communicably connected to one another via a network. The network includes one or more networks such as the Internet, a portable communication network and a LAN (local area network). The LAN may be a wireless LAN or may be a wired LAN.

FIG. 1 illustrates one terminal 4. However, the information processing system SY can include a plurality of terminals 4. FIG. 1 illustrates one first checkout machine 5. However, the information processing system SY can include a plurality of first checkout machines 5. FIG. 1 illustrates one second checkout machine 6. The information processing system SY can include a plurality of second checkout machines 6. The information processing system SY sometimes indicates a system including at least two devices.

The transaction management server 1 is a device that manages transactions in the store ST. Each transaction in store ST has a first transaction ID associated therewith. In this context, a transaction is a commercial transaction involving an exchange of a commodity between a user or customer and the store ST. Commodity registration performed using the terminal 4 may be of a form in which the terminal 4 itself stores a commodity master DB (database) (hereinafter simply referred to a commodity master). In this example, the terminal 4 checks the commodity master using a commodity code and acquires commodity information corresponding to the commodity code from the commodity master. The terminal 4 registers the acquired commodity information in the terminal 4 as a part of the transaction information. Instead of this format, the commodity registration performed using the terminal 4 may be of a form in which the transaction management server 1 (rather than the terminal 4) stores the commodity master. In such a case, the terminal 4 outputs the acquired commodity code to the transaction management server 1 as a part of a request for registration. The transaction management server 1 checks the commodity master and acquires commodity information corresponding to the acquired commodity code from the commodity master. The transaction management server 1 registers the acquired commodity information in the transaction management server 1 as part of the transaction information. In the following explanation examples, the system in which the transaction management server 1 stores the commodity master is used.

In the following explanation, it is assumed that, unless noted otherwise, the term “transaction” refers to a transaction based on commodity registration performed using the terminal 4 by the user. A first transaction ID is identification information for uniquely identifying a transaction. The transaction management server 1 is capable of using the first transaction ID. The transaction management server 1 is capable of processing data based on the first transaction ID. The first transaction ID can be determined according to a particular code scheme usable in the transaction management server 1. For example, the first transaction ID has a six or more digit number. However, the code scheme is not limited to this.

The electronic receipt server 2 is a device that provides an electronic receipt for each of transactions. The electronic receipt is an image indicating details of the transaction that can be displayed on electronic equipment.

The online settlement server 3 is a device that communicates with the terminal 4 to perform an online settlement of a transaction using the terminal 4. The online settlement server 3 performs various online settlements using the terminal 4 by the user. The online settlement is a non-cash settlement performed via a network using a credit card, a debit card, electronic money, a code settlement, or a point. In the following explanation, it is assumed that the phrase “a transaction online settlement performed using the terminal 4” indicates an online settlement made not via the first checkout machine 5 or the second checkout machine 6 but rather based on communication between the terminal 4 and the online settlement server 3.

The terminal 4 is a device used in shopping in the store ST by a user. The terminal 4 is capable of performing commodity registration by the user. The commodity registration in this context means registering a commodity as a target of a transaction. The terminal 4 is a portable or mobile device that can be carried by the user. The terminal 4 may be mounted on a shopping cart in some cases. The terminal 4 may be a terminal provided by the store ST or may be a terminal owned by the user. The terminal 4 may be a tablet terminal, a smartphone, or the like or may be a combination of the tablet terminal or the smartphone and external equipment operating in conjunction. The terminal 4 stores an application program used in shopping in the store ST. In the following explanation, the application program used in the shopping in the store ST is also referred to as a shopping application (“shopping app”).

The first checkout machine 5 is a device capable of processing a settlement of a transaction. The first checkout machine 5 is capable of processing either of an online settlement or an offline settlement by cash. The first checkout machine 5 is capable of using a first transaction ID. The first checkout machine 5 is capable of processing data based on the first transaction ID. The first transaction ID can be generated according to any code scheme usable in the first checkout machine 5.

The second checkout machine 6 is a device capable of processing a settlement of a transaction. The second checkout machine 6 is capable of processing either of an online settlement or an offline settlement. The second checkout machine 6 is capable of using a second transaction ID. The second checkout machine 6 is capable of processing data based on the second transaction ID. A code scheme of the second transaction ID is different from a code scheme of the first transaction ID. For example, the second transaction ID has a smaller number of digits than the first transaction ID. In this example, the code scheme of the second transaction ID generates a four digits or less number. The form in which the code scheme of the second transaction ID is different from the code scheme of the first transaction ID is not limited to the number of digits. Note that the second checkout machine 6 in this example is not capable of using the first transaction ID. The second checkout machine 6 is not capable of processing data based on the first transaction ID. Thus, the first transaction ID is generated according to a code scheme that is not usable by the second checkout machine 6. The second checkout machine 6 is also referred to as an information processing device. A configuration example of the second checkout machine 6 is explained below.

In the information processing system SY explained above, the user performs shopping as explained below. The user moves around in the store ST together with the terminal 4. The user uses the terminal 4 to read a code symbol attached to a commodity. The terminal 4 acquires a commodity ID (referred to as a commodity code as well) of the commodity from the code symbol based on the reading of the code symbol. The commodity ID is identification information for identifying the commodity. The terminal 4 performs commodity registration based on the commodity ID. The user puts the registered commodity in a shopping cart. The registered commodity is the commodity registered using the terminal 4. After ending the commodity registration using the terminal 4, the user performs a settlement of a transaction. The user can perform a settlement of the transaction performed using the first checkout machine 5. The user can perform an online settlement of the transaction performed using the terminal 4. In the latter case, the user does not need to perform the settlement of the transaction using the first checkout machine 5. According to completion of the settlement of the transaction, the user ends the shopping performed using the shopping application.

A configuration example of the transaction management server 1 is explained.

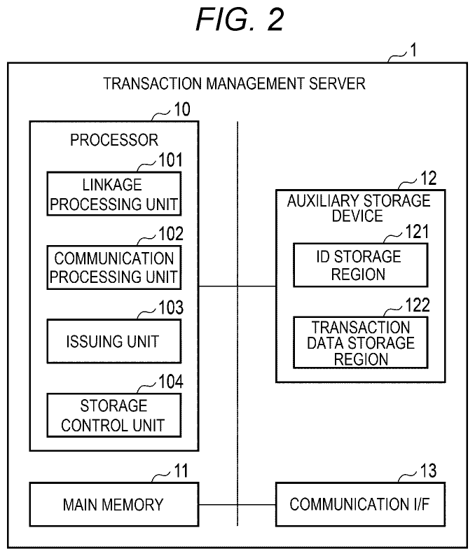

FIG. 2 is a block diagram illustrating an overview of a configuration of the transaction management server 1.

The transaction management server 1 includes a processor 10, a main memory 11, an auxiliary storage device 12, and a communication interface 13. In FIG. 2, interface is described as “I/F”.

The processor 10 is a core component of the transaction management server 1. The processor 10 includes various circuits such as a CPU (central processing unit). The processor 10 loads, into the main memory 11, a program stored in advance in the main memory 11 or the auxiliary storage device 12. The program is executed by the processor 10 to function as the units explained below. The processor 10 executes various kinds of processing by executing the program loaded in the main memory 11.

The main memory 11 includes a nonvolatile memory region and a volatile memory region. The nonvolatile memory region of the main memory 11 stores an operating system and programs. The volatile memory region of the main memory 11 is used as a work area in which data is rewritten as appropriate by the processor 10. For example, the main memory 11 includes a ROM (read only memory) as the nonvolatile memory region. For example, the main memory 11 includes a RAM (random access memory) as the volatile memory region.

The auxiliary storage device 12 includes an EEPROM (registered trademark) (electric erasable programmable read-only memory), an HDD (hard disc drive), an SSD (solid state drive), a flash memory, or the like but is not limited to these. The auxiliary storage device 12 stores the programs explained above, data to be used by the processor 10 in performing various kinds of processing, and data to be generated by the processor 10.

The auxiliary storage device 12 includes an ID storage region 121. If a shopping member ID and an electronic receipt member ID are linked as explained below, the ID storage region 121 stores the shopping member ID and the electronic receipt member ID for each of users. The shopping member ID and the electronic receipt member ID are associated with each other. The shopping member ID is identification information for identifying the terminal 4 that uses a shopping service in the shopping application in the store ST. The electronic receipt member ID is identification information for identifying a user who uses an electronic receipt service in the terminal 4.

The auxiliary storage device 12 includes a transaction data storage region 122. The transaction data storage region 122 stores, for each of transactions, a first transaction ID, a shopping member ID, an electronic receipt member ID, transaction data, and settlement status information. The first transaction ID, the shopping member ID, the electronic receipt member ID, the transaction data, and the settlement status information are associated with one another. The transaction data is data concerning a transaction. The transaction data includes commodity data about commodities that become targets of the transaction based on commodity registration. For example, the commodity data includes data such as a commodity ID, a commodity name, the number of items, and an amount. The commodity name is a name of a commodity. The number of items is the number of commodities specified by the same commodity ID. The amount is a total amount of the commodities specified by the same commodity ID. The settlement status information is information indicating a settlement status of the transaction. If the transaction is unsettled, the settlement status information is information indicating unsettlement of the transaction. If the transaction is settlement-completed, the settlement status information is information indicating completion of the settlement of the transaction. If the transaction is settlement-completed, the settlement status information includes settlement method information. The settlement method information is information indicating a settlement method for the transaction. If the settlement method for the transaction is online settlement of the transaction performed using the terminal 4, the settlement method information is information indicating the online settlement of the transaction performed using the terminal 4. If the settlement method for the transaction is settlement of the transaction performed using the first checkout machine 5, the settlement method information is information indicating settlement of the transaction performed using the first checkout machine 5.

The communication interface 13 is a network interface circuit for connecting the transaction management server 1 to other devices.

Note that a hardware configuration of the transaction management server 1 is not limited to the configuration explained above. One or more of the components explained above can be omitted or changed and one or more other components can be added as appropriate.

The functions performed by the processor 10 are explained.

The processor 10 functions as a linkage processing unit 101, a communication processing unit 102, an issuing unit 103, and a storage control unit 104. Those functions can also be performed by a controller including the processor 10 and the main memory 11.

The linkage processing unit 101 processes linkage of a shopping member ID and an electronic receipt member ID.

The communication processing unit 102 acquires data from other devices via the communication interface 13. For example, the communication processing unit 102 acquires, from the terminal 4, based on commodity registration performed using the terminal 4 by the user, a commodity ID concerning the commodity registration read by the terminal 4. For example, the communication processing unit 102 acquires notification from the online settlement server 3. The notification includes, about an online settlement of a transaction performed using the terminal 4, completion of the settlement of the transaction or unsettlement of the transaction as a settlement status of the transaction. For example, the communication processing unit 102 acquires the notification from the first checkout machine 5. The notification includes, about settlement of a transaction performed using the first checkout machine 5, completion of the settlement of the transaction or unsettlement of the transaction as a settlement status of the transaction. The communication processing unit 102 outputs data to other devices via the communication interface 13. In the following explanation, the terms “communication processing unit 102” may also be considered to be read as “communication interface 13”.

The issuing unit 103 issues a first transaction ID for each transaction.

The storage control unit 104 stores data in the auxiliary storage device 12. For example, the storage control unit 104 updates transaction data based on a commodity ID acquired from the terminal 4 by the communication processing unit 102. For example, the storage control unit 104 updates settlement status information based on notification acquired from the online settlement server 3 or the first checkout machine 5 by the communication processing unit 102.

A configuration example of the electronic receipt server 2 is explained.

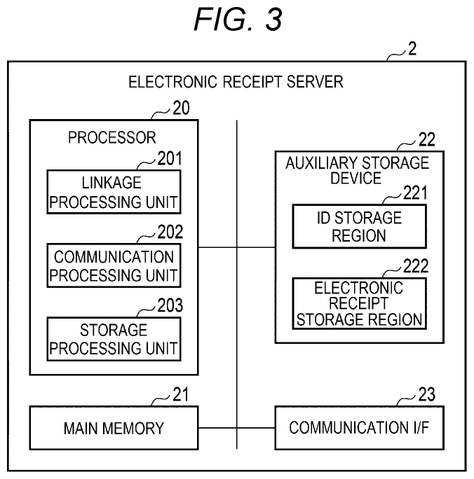

FIG. 3 is a block diagram illustrating an overview of a configuration of the electronic receipt server 2.

The electronic receipt server 2 includes a processor 20, a main memory 21, an auxiliary storage device 22, and a communication interface 23. In FIG. 3, interface is described as “I/F”.

The processor 20 is a core component of the electronic receipt server 2. The processor 20 may have the same configuration as the processor 10. The processor 20 loads, into the main memory 21, a program stored in advance in the main memory 21 or the auxiliary storage device 22. The program is executed by the processor 20 to function as the units explained below. The processor 20 executes various kinds of processing by executing the program loaded into the main memory 21.

The main memory 21 may have the same hardware configuration as the main memory 11.

The auxiliary storage device 22 may have the same configuration as the auxiliary storage device 12.

The auxiliary storage device 22 includes an ID storage region 221. If a shopping member ID and an electronic receipt member ID are linked as explained below, the ID storage region 221 stores the shopping member ID and the electronic receipt member ID for each of users. The member ID and the electronic receipt member ID are associated with each other.

The auxiliary storage device 22 includes an electronic receipt storage region 222. The electronic receipt storage region 222 stores, for each of transactions, an electronic receipt member ID, a transaction ID, transaction data, and electronic receipt data. The electronic receipt member ID, the transaction ID, the transaction data, and the electronic receipt data are associated with one another. The transaction ID is a first transaction ID or a second transaction ID. The transaction data stored in the electronic receipt storage region 222 is transaction data concerning a settlement-completed transaction. The electronic receipt data is data of an electronic receipt generated based on the transaction data. The electronic receipt includes a transaction ID associated with the electronic receipt data. The electronic receipt may include the transaction ID as a character string or may include a code symbol in which the transaction ID is stored.

The communication interface 23 is a network interface circuit for communicably connecting the electronic receipt server 2 to other devices.

Note that a hardware configuration of the electronic receipt server 2 is not limited to the configuration explained above. One or more of the components explained above can be omitted or changed and one or more other components can be added as appropriate.

The functions performed by the processor 20 are explained.

The processor 20 functions as a linkage processing unit 201, a communication processing unit 202, and a storage control unit 203. Those functions can also be performed by a controller including the processor 20 and the main memory 21.

The linkage processing unit 201 processes linkage of a shopping member ID and an electronic receipt member ID.

The communication processing unit 202 acquires data from other devices via the communication interface 23. The communication processing unit 202 outputs data to the other devices via the communication interface 23. In the following explanation, the term “communication processing unit 202” may be considered to be read as “communication interface 23”.

The storage control unit 203 stores the data in the auxiliary storage device 22.

A configuration example of the first checkout machine 5 is explained.

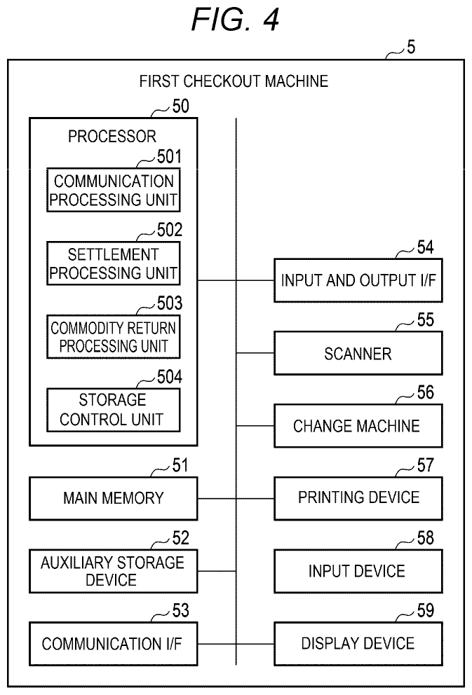

FIG. 4 is a block diagram illustrating an overview of a configuration of the first checkout machine 5.

The first checkout machine 5 includes a processor 50, a main memory 51, an auxiliary storage device 52, a communication interface 53, an input and output interface 54, a scanner 55, a change machine 56, a printing device 57, an input device 58, and a display device 59. In FIG. 4, interface is described as “I/F”.

The processor 50 is a core component of the first checkout machine 5. The processor 50 may have the same hardware configuration as the processor 10 explained above. The processor 50 loads, into the main memory 51, a program stored in advance in the main memory 51 or the auxiliary storage device 52. The program is executed by the processor 50 to function as the units explained below. The processor 50 executes various kinds of processing by executing the program loaded into the main memory 51.

The main memory 51 may have the same hardware configuration as the hardware configuration of the main memory 11 explained above. The main memory 51 stores a program.

The auxiliary storage device 52 may have the same hardware configuration as the hardware configuration of the auxiliary storage device 12 explained above. The auxiliary storage device 52 stores the program explained above, data to be used by the processor 50 in performing various kinds of processing, and data to be generated by the processing in the processor 50.

The communication interface 53 is a network interface circuit for communicably connecting the first checkout machine 5 to other devices.

The input and output interface 54 includes various interface circuits that communicably connect the first checkout machine 5 to other electronic equipment by directly connecting the first checkout machine 5 to the other electronic equipment by wire or radio. For example, the input and output interfaces 54 connects the first checkout machine 5 to a card reader. The card reader is a device that reads card data recorded in a magnetic stripe of a card medium or an IC (Integrated Circuit) chip. The card medium may include a credit card.

The scanner 55 is a device that reads various code symbols and acquires data from the code symbols. The scanner 55 may include a scanner of a type including an imaging element such as a CCD (Charge-Coupled Device) or may include a laser-type scanner. The code symbols may include a code symbol for code settlement.

The change machine 56 is a device that dispenses bills and/or coins equivalent to a change amount.

The printing device 57 is a device for printing a receipt. For example, the printing device 57 is a thermal printer, an inkjet printer, or the like.

The input device 58 is a device capable of inputting an instruction to the first checkout machine 5. The input device 58 may include, for example, a keyboard. The input device 58 may include a touch screen configured together with the display device 59.

The display device 59 is a device capable of displaying various images. For example, the display device 59 is a liquid crystal display, an EL (Electroluminescence) display, or the like.

Note that a hardware configuration of the first checkout machine 5 is not limited to the configuration explained above. One or more of the components explained above can be omitted or changed and one or more other components can be added as appropriate.

The functions performed by the processor 50 are explained.

The processor 50 functions as a communication processing unit 501, a settlement processing unit 502, a commodity return processing unit 503, and a storage control unit 504. Those functions can also be performed by a controller including the processor 50 and the main memory 51.

The communication processing unit 501 acquires data from other devices via the communication interface 53. The communication processing unit 501 outputs data to the other devices via the communication interface 53. In the following explanation, the term “communication processing unit 501” may be considered to be read as “communication interface 53”.

The settlement processing unit 502 processes a settlement of a transaction.

The commodity return processing unit 503 processes commodity return in a settlement-completed transaction. The commodity return processing is processing for refunding from the store ST to the user in exchange for a commodity returned from a customer, who is the user, to the store ST. The refund may be cash or may be non-cash. A target of the commodity return may be all commodities in the transaction or may be a part of the commodities.

The storage control unit 504 stores data in the auxiliary storage device 52.

A configuration example of the second checkout machine 6 is explained.

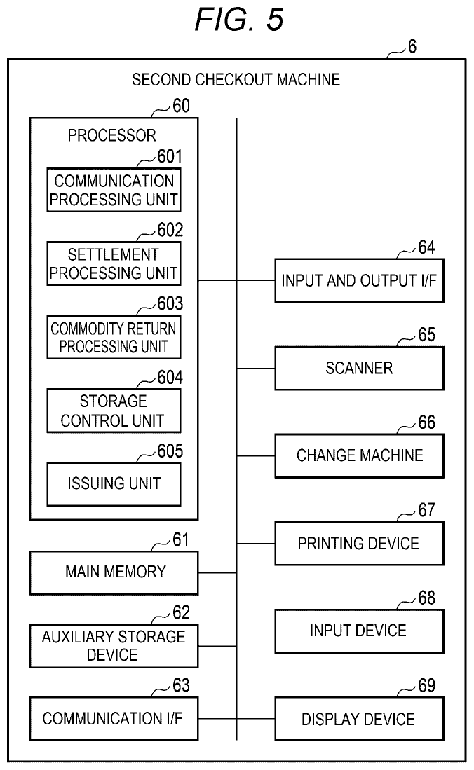

FIG. 5 is a block diagram illustrating an overview of a configuration of the second checkout machine 6.

The second checkout machine 6 includes a processor 60, a main memory 61, an auxiliary storage device 62, a communication interface 63, an input and output interface 64, a scanner 65, a change machine 66, a printing device 67, an input device 68, and a display device 69. In FIG. 5, interface is described as “I/F”.

The processor 60 is a core component of the second checkout machine 6. The processor 60 may have the same hardware configuration as the processor 10 explained above. The processor 60 loads, into the main memory 61, a program stored in advance in the main memory 61 or the auxiliary storage device 62. The program is executed by the processor 60 to function as the units explained below. The processor 60 executes various kinds of processing by executing the program loaded into the main memory 61.

The main memory 61 may have the same hardware configuration as the hardware configuration of the main memory 11 explained above. The main memory 61 stores a program.

The auxiliary storage device 62 may have the same hardware configuration as the hardware configuration of the auxiliary storage device 12 explained above. The auxiliary storage device 62 stores the program explained above, data to be used by the processor 60 in performing various kinds of processing, and data to be generated by processing in the processor 60.

The communication interface 63 is a network interface circuit for communicably connecting the second checkout machine 6 to other devices.

The input and output interface 64 includes various interface circuits that communicably connect the second checkout machine 6 to other electronic equipment by directly connecting the second checkout machine 6 to the other electronic equipment by wire or radio. For example, the input and output interface 64 connect the second checkout machine 6 to a card reader.

The scanner 65 is a device that reads various code symbols and acquires data from the code symbols. The scanner 65 may have the same hardware configuration as the hardware configuration of the scanner 55.

The checkout machine 66 is a device that dispenses bills and/or coins equivalent to a change amount.

The printing device 67 is for printing a receipt. The printing device 67 may have the same hardware configuration as the hardware configuration of the printing device 57.

The input device 68 is a device capable of inputting an instruction to the second checkout machine 6. The input device 68 may have the same hardware configuration as the hardware configuration of the input device 58.

The display device 69 is capable of displaying various images. The display device 69 may have the same hardware configuration as the hardware configuration of the display device 59.

Note that a hardware configuration of the second checkout machine 6 is not limited to the configuration explained above. One or more of the components explained above can be omitted or changed and one or more other components can be added as appropriate.

The functions performed by the processor 60 are explained.

The processor 60 functions as a communication processing unit 601, a settlement processing unit 602, a commodity return processing unit 603, a storage control unit 604, and an issuing unit 605. Those functions can also be performed by a controller including the processor 60 and the main memory 61.

The communication processing unit 601 acquires data from other devices via the communication interface 63. The communication processing unit 601 outputs data to the other devices via the communication interface 63. In the following explanation, the term “communication processing unit 601” may be considered to be read as “communication interface 63”.

The settlement processing unit 602 processes a settlement of a transaction based on commodity registration performed using the terminal 4 by the user.

The commodity return processing unit 603 processes commodity return in a settlement-completed transaction.

The storage control unit 604 stores data in the auxiliary storage device 62.

The issuing unit 605 issues a second transaction ID for each of transactions.

### Display Example

Various images displayed on the terminal 4 are explained.

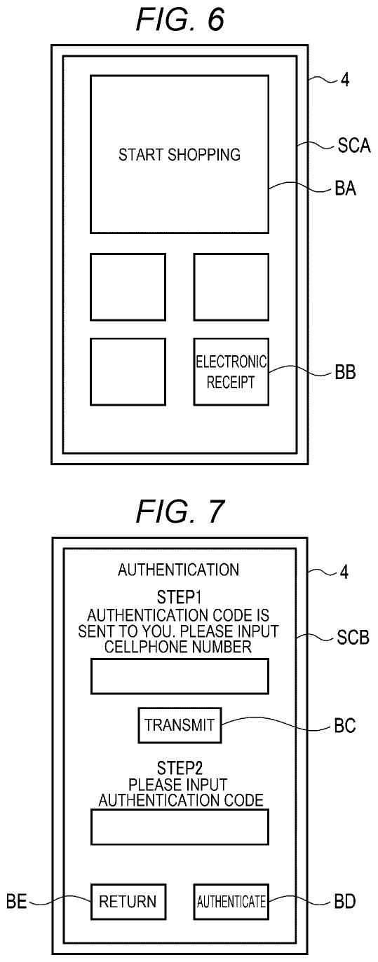

FIG. 6 is a diagram illustrating a display example of a transaction top screen SCA displayed on the terminal 4.

The transaction top screen SCA is an image displayed on the terminal 4 based on a start of a shopping application in the terminal 4. The user starts the shopping application in the terminal 4 when starting shopping in the store ST.

The transaction top screen SCA displays a shopping start button BA selectable by the user. The shopping start button BA is a button for starting commodity registration performed using the terminal 4 by the user. The transaction top screen SCA displays an electronic receipt button BB selectable by the user. The electronic receipt button BB is a button for displaying an image concerning an electronic receipt. For example, the image concerning the electronic receipt includes an electronic receipt top screen explained below and an electronic receipt designated by the user. The image concerning the electronic receipt may be an image displayed on the terminal 4 with an in-app browser by a Web browser function incorporated in the shopping application.

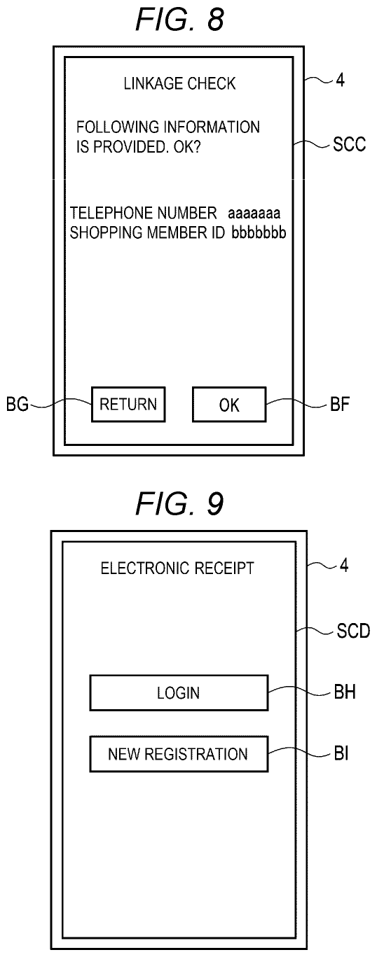

FIG. 7 is a diagram illustrating a display example of a personal authentication screen SCB displayed on the terminal 4.

The personal authentication screen SCB is an image displayed on the terminal 4 in order to link a shopping member ID and an electronic receipt member ID. If the shopping member ID and the electronic receipt member ID are not linked, it is assumed that the user has selected the electronic receipt button BB on the transaction top screen SCA illustrated in FIG. 6. An image displayed on the terminal 4 transitions from the transaction top screen SCA to the personal authentication screen SCB based on selection of the electronic receipt button BB on the transaction top screen SCA. The personal authentication screen SCB displays a transmission button BC selectable by the user. The transmission button BC is a button for outputting, from the terminal 4 to the transaction management server 1, a telephone number of the terminal 4 input by the user on the personal authentication screen SCB. The telephone number is used for the terminal 4 to acquire an authentication code from the electronic receipt server 2. The authentication code is a code for authenticating the terminal 4. The personal authentication screen SCB displays an authentication button BD selectable by the user. The authentication button BD is a button for outputting, from the terminal 4 to the transaction management server 1, the authentication code input by the user on the personal authentication screen SCB. The personal authentication screen SCB displays a return button BE selectable by the user. The return button BE is a button for transitioning the image displayed on the terminal 4 from the personal authentication screen SCB to the transaction top screen SCA.

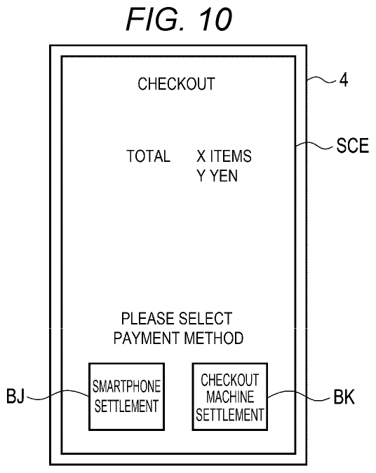

FIG. 8 is a diagram illustrating a display example of a linkage check screen SCC displayed on the terminal 4.

The linkage check screen SCC is an image displayed on the terminal 4 in order to link a shopping member ID and an electronic receipt member ID. It is assumed that the user has selected the authentication button BD on the personal authentication screen SCB illustrated in FIG. 7. The image displayed on the terminal 4 transitions from the personal authentication screen SCB to the linkage check screen SCC based on the selection of the authentication button BD on the personal authentication screen SCB. The linkage check screen SCC displays an OK button BF selectable by the user. The OK button BF is a button for outputting a shopping member ID set in the terminal 4 from the terminal 4 to the transaction management server 1. The linkage check screen SCC displays a return button BG selectable by the user. The return button BG is a button for transitioning the image displayed on the terminal 4 from the linkage check screen SCC to the transaction top screen SCA. Note that, after linkage of a shopping member ID and an electronic receipt member ID, the terminal 4 may store only the shopping member ID or may store both of the shopping member ID and the electronic receipt member ID.

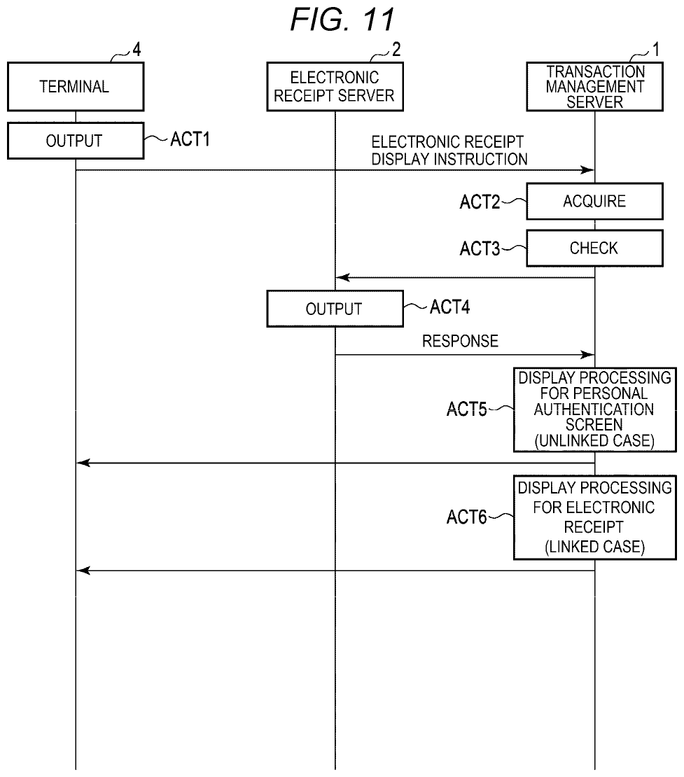

FIG. 9 is a diagram illustrating a display example of an electronic receipt top screen SCD displayed on the terminal 4.

The electronic receipt top screen SCD is an image displayed on the terminal 4 after the selection of the electronic receipt button BB on the transaction top screen SCA. The electronic receipt top screen SCD may be an image displayed on the terminal 4 by the in-app browser. A case in which a shopping member ID and an electronic receipt member ID are not linked is explained. In this case, the image displayed on the terminal 4 transitions in the order of the transaction top screen SCA, the personal authentication screen SCB, the linkage check screen SCC, and the electronic receipt top screen SCD based on the selection of the electronic receipt button BB on the transaction top screen SCA. A case in which the shopping member ID and the electronic receipt member ID are linked is explained. In this case, the image displayed on the terminal 4 transitions from the transaction top screen SCA to the electronic receipt top screen SCD based on the selection of the electronic receipt button BB on the transaction top screen SCA. Note that, if the user has already been registered as a member for the electronic receipt service, the terminal 4 can store an electronic receipt member ID and a password. In this case, the terminal 4 omits the display of the electronic receipt top screen SCD and displays an image concerning an electronic receipt based on the selection of the electronic receipt button BB on the transaction top screen SCA. The electronic receipt top screen SCD displays a login button BH selectable by the user. The login button BH is a button for displaying a login screen to which the user registered as the member for the electronic receipt service inputs the electronic receipt member ID and the password. The electronic receipt top screen SCD displays a new registration button BI selectable by the user. The new registration button BI is a button for displaying a new registration screen for a user, who is not a member of the electronic receipt service, to register the user as a member anew.

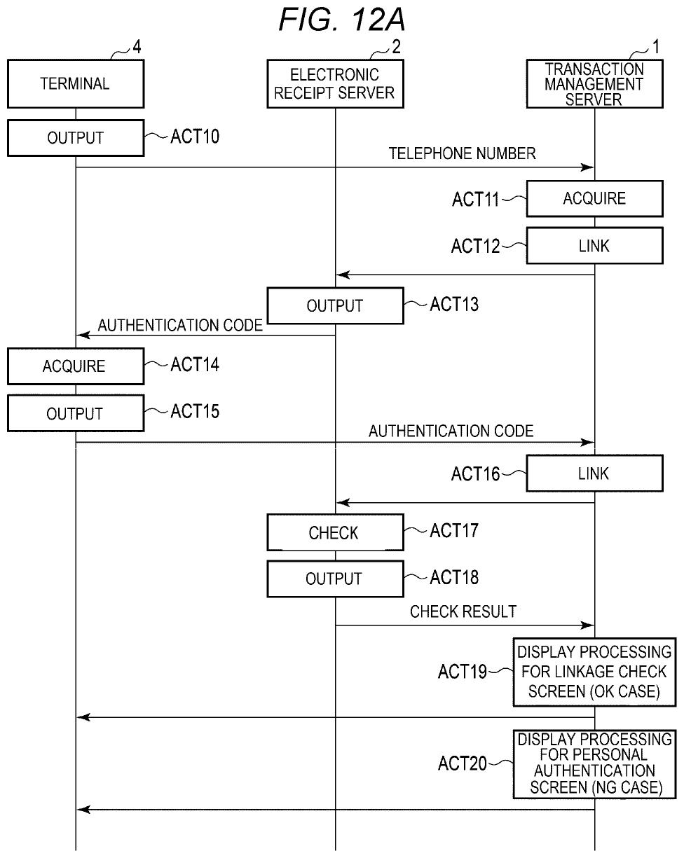

FIG. 10 is a diagram illustrating a display example of the settlement selection screen SCE displayed on the terminal 4.

The settlement selection screen SCE is an image displayed on the terminal 4 in a scene in which a settlement method for a transaction is selected after the selection of the shopping start button BA on the transaction top screen SCA. The settlement selection screen SCE displays a smartphone settlement button BJ selectable by the user. The smartphone settlement button BJ is a button for performing an online settlement of a transaction performed using the terminal 4. An image displayed on the terminal 4 transitions, based on the selection of the smartphone settlement button BJ, from the settlement selection screen SCE to a screen concerning the online settlement for the transaction performed using the terminal 4. The settlement selection screen SCE displays a checkout machine settlement button BK selectable by the user. The checkout machine settlement button BK is a button for performing a settlement of a transaction performed using the first checkout machine 5. An image displayed on the terminal 4 transitions, based on the selection of the checkout machine settlement button BK, from the settlement selection screen SCE to a screen concerning the settlement of the transaction performed using the first checkout machine 5.

### Operation Example

Next, processing in the information processing system SY is explained.

Note that the series of processing steps explained below is only an example, and it may be changed as appropriate. Omission, substitution, and addition of steps are possible as appropriate.

Note that the terminal 4 explained as a subject below may read a processor of the terminal 4. The online settlement server 3 explained as a subject below may read a processor of the online settlement server 3.

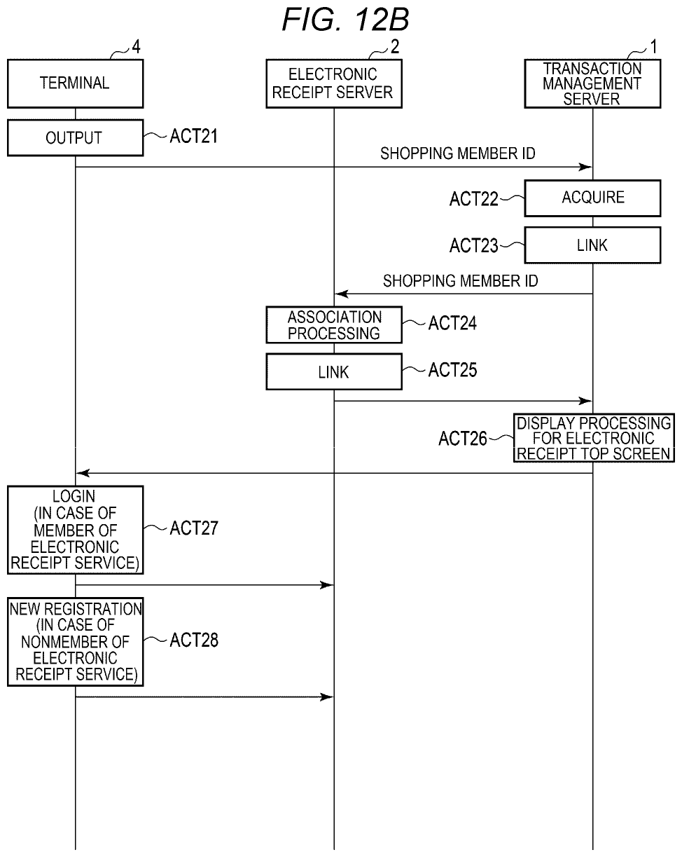

FIG. 11 is a sequence chart illustrating an example of display processing for an electronic receipt in the information processing system SY.

The display processing for the electronic receipt is processing performed after the user selected the electronic receipt button BB on the transaction top screen SCA displayed on the terminal 4.

The terminal 4 outputs an electronic receipt display instruction to the transaction management server 1 based on the selection of the electronic receipt button BB on the transaction top screen SCA by the user (ACT 1). The electronic receipt display instruction is an instruction for causing the terminal 4 to display an electronic receipt. The electronic receipt display instruction includes a shopping member ID. If the shopping member ID and an electronic receipt member ID are not linked, the display instruction sometimes does not include the shopping member ID.

The processor 10 of the transaction management server 1 acquires the electronic receipt display instruction from the terminal 4 (ACT 2). The processor 10 checks with the electronic receipt server 2, using an inquiry API (application programming interface), whether the shopping member ID included in the electronic receipt display instruction has been linked with an electronic receipt member ID.

The processor 20 of the electronic receipt server 2 outputs, to the transaction management server 1, a response indicating whether the shopping member ID has been linked with the electronic receipt member ID (ACT 4). In ACT 4, for example, the processor 20 checks, based on data stored in the ID storage region 221, whether the shopping member ID and the electronic receipt member ID have been linked.

The processor 10 of the transaction management server 1 acquires the response from the electronic receipt server 2. If the shopping member ID has not been linked with the electronic receipt member ID, the processor 10 outputs, to the terminal 4, information for causing the terminal 4 to display the personal authentication screen SCB (ACT 5). If the shopping member ID has been linked with the electronic receipt member ID, the processor 10 outputs, to the terminal 4, information for causing the terminal 4 to display an electronic receipt (ACT 6). The terminal 4 may display the electronic receipt with the in-app browser. Here, the terminal 4 outputs the electronic receipt member ID and the password stored in the terminal 4 to the transaction management server 1, whereby login is performed without requiring operation of the user. Therefore, the processor 10 omits processing for causing the terminal 4 to display the electronic receipt top screen SCD. If the terminal 4 does not store the electronic receipt member ID and the password, the processor 10 outputs, to the terminal 4, information for causing the terminal 4 to display the electronic receipt top screen SCD.

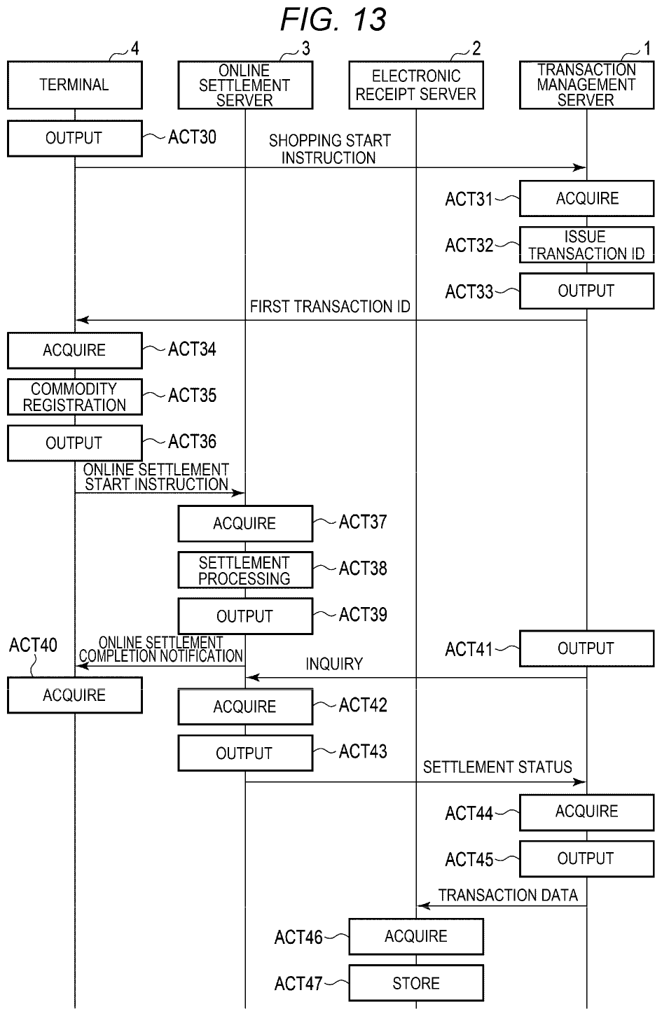

FIG. 12A and FIG. 12B are sequence charts illustrating an example of linkage processing for associating a shopping member ID and an electronic receipt member ID in the information processing system SY.

The linkage processing is processing for storing, in one or both of the transaction management server 1 and the electronic receipt server 2, a shopping member ID and an electronic receipt member ID associated with each other.

Here, it is assumed that the terminal 4 is displaying the personal authentication screen SCB based on the processing in ACT 5 by the processor 10 of the transaction management server 1.

The terminal 4 outputs, after a telephone number of the terminal 4 being input on the personal authentication screen SCB, the telephone number to the transaction management server 1 based on selection of the transmission button BC (ACT 10).

The linkage processing unit 101 of the transaction management server 1 acquires the telephone number from the terminal 4 (ACT 11). The linkage processing unit 101 links with the electronic receipt server 2 using an authentication code issue API (ACT 12).

The linkage processing unit 201 of the electronic receipt server 2 outputs an authentication code to the telephone number acquired from the transaction management server 1 (ACT 13).

The terminal 4 acquires, from the electronic receipt server 2, the authentication code output to the telephone number (ACT 14). The terminal 4 outputs the authentication code to the transaction management server 1 based on selection of the authentication button BD after the authentication code being input on the personal authentication screen SCB (ACT 15).

The linkage processing unit 101 of the transaction management server 1 links with the electronic receipt server 2 based on acquisition of the authentication code from the terminal 4 using an authentication code check API (ACT 16).

The linkage processing unit 201 of the electronic receipt server 2 checks validity of the authentication code acquired from the terminal 4 by the transaction management server 1 (ACT 17). In ACT 17, for example, the linkage processing unit 201 compares the authentication code output to the telephone number of the terminal 4 and the authentication code acquired from the terminal 4 by the transaction management server 1. The linkage processing unit 201 checks the validity of the authentication code based on the comparison. The linkage processing unit 201 outputs a check result to the transaction management server 1 (ACT 18). The check result indicates that the authentication code is valid or the authentication code is invalid.

The linkage processing unit 101 of the transaction management server 1 acquires the check result from the electronic receipt server 2. If the authentication code is valid (described as OK in FIG. 12A), the linkage processing unit 101 outputs, to the terminal 4, information for causing the terminal 4 to display the linkage check screen SCC (ACT 19). If the authentication code is invalid (described as NG in FIG. 12A), the linkage processing unit 101 outputs, to the terminal 4, information for causing the terminal 4 to display the personal authentication screen SCB (ACT 20). The user can input the authentication code again on the personal authentication screen SCB.

It is assumed that the terminal 4 is displaying the linkage check screen SCC based on the processing in ACT 19 by the linkage processing unit 101 of the transaction management server 1. The terminal 4 outputs, based on selection of the OK button BF on the linkage check screen SCC, a shopping member ID set in the terminal 4 to the transaction management server 1 (ACT 21).

The linkage processing unit 101 of the transaction management server 1 acquires the shopping member ID from the terminal 4 (ACT 22). The linkage processing unit 101 links with the electronic receipt server 2 using a token issue API (ACT 23).

The linkage processing unit 201 of the electronic receipt server 2 issues a token and starts processing for associating an electronic receipt member ID with the shopping member ID acquired from the transaction management server 1 (ACT 24). The linkage processing unit 201 includes the issued token in parameters of a URL (Uniform Resource Locator) and links with the transaction management server 1 (ACT 25).

The linkage processing unit 101 of the transaction management server 1 outputs, based on the parameters of the URL, to the terminal 4, information for causing the terminal 4 to display the electronic receipt top screen SCD (ACT 26).

The terminal 4 displays the electronic receipt top screen SCD. If the user is a member of the electronic receipt service, the user selects the login button BH on the electronic receipt top screen SCD. The terminal 4 displays a login screen based on the selection of the login button BH by the user (ACT 27). The terminal 4 outputs, to the electronic receipt server 2, an electronic receipt member ID and a password input by the user on the login screen. If the user is not a member of the electronic receipt service, the user selects the new registration button BI on the electronic receipt top screen SCD. The terminal 4 displays a new registration screen based on the selection of the new registration button BI by the user (ACT 28). The terminal 4 outputs, to the electronic receipt server 2, an electronic receipt member ID and a password for new registration input by the user on the new registration screen. The linkage processing unit 201 of the electronic receipt server 2 associates the electronic receipt member ID acquired from the terminal 4 with the shopping member ID. The linkage processing unit 201 stores, in the ID storage region 221, the shopping member ID and the electronic receipt member ID associated with each other. Consequently, the shopping member ID and the electronic receipt member ID are linked. The linkage processing unit 101 of the acquisition management server 1 acquires, from the electronic receipt server 2, the shopping member ID and the electronic receipt member ID associated with each other and stores the shopping member ID and the electronic receipt member ID in the ID storage region 121.

As explained above, it is possible to link the shopping member ID for using the shopping service with the shopping application and the electronic receipt member ID for using the electronic receipt service. Consequently, it is possible to link transaction data concerning a settlement-completed transaction performed using the shopping application with the electronic receipt service irrespective of a settlement method for a transaction.

Next, three examples of linkage processing for associating transaction data concerning a settlement-completed transaction with the electronic receipt server 2 in the information processing system SY are explained. In the following explanation, it is assumed that the term “transaction data” refers to transaction data concerning a settlement-completed transaction (a completed transaction) unless noted otherwise.

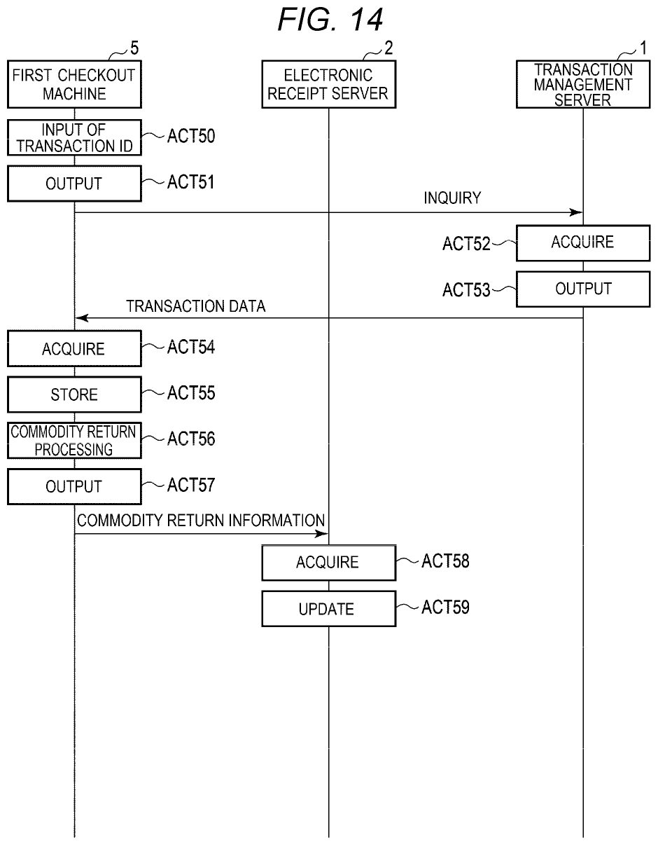

FIG. 13 is a sequence chart illustrating a first example of linkage processing for associating transaction data with the electronic receipt server 2 in the information processing system SY.

The first example is an example in which the transaction management server 1 links transaction data stored in the transaction management server 1 with the electronic receipt server 2.

The terminal 4 outputs a shopping start instruction to the transaction management server 1 based on selection of the shopping start button BA on the transaction top screen SCA (ACT 30). The shopping start instruction is an instruction to start shopping performed using the shopping application. The shopping start instruction includes the shopping member ID stored in the terminal 4.

The communication processing unit 102 of the transaction management server 1 acquires the shopping start instruction from the terminal 4 (ACT 331). The issuing unit 103 issues a first transaction ID for a transaction performed using the terminal 4 (ACT 32). Here, it is assumed that the issuing unit 103 issues a first transaction ID concerning a transaction X. The storage control unit 104 stores, in the transaction data storage region 122, the first transaction ID issued from the issuing unit 103. The storage control unit 104 stores the shopping member ID acquired from the terminal 4 in the transaction data storage region 122 in association with the first transaction ID concerning the transaction X. The storage control unit 104 acquires an electronic receipt member ID associated with the shopping member ID from the ID storage region 121. The storage control unit 104 stores the acquired electronic receipt member ID in the transaction data storage region 122 in association with the first transaction ID concerning the transaction X. The communication processing unit 102 outputs, to the terminal 4, the first transaction ID concerning the transaction X issued by the issuing unit 103 (ACT 33). The communication processing unit 102 may output the electronic receipt member ID concerning the transaction X to the terminal 4.

The terminal 4 acquires the first transaction ID concerning the transaction X from the transaction management server 1 (ACT 34). The terminal 4 stores the acquired first transaction ID concerning the transaction X in its auxiliary storage device. If acquiring an electronic receipt member ID concerning the transaction X, the terminal 4 stores the acquired electronic receipt member ID concerning the transaction X in the auxiliary storage device. The terminal 4 executes commodity registration for the transaction X identified by the first transaction ID based on user operation (ACT 35). If ending the commodity registration performed using the terminal 4, the user performs a settlement of a transaction. It is assumed that the user selects, as a settlement method for a transaction, online settlement of a transaction performed using the terminal 4. The terminal 4 outputs an online settlement start instruction to the online settlement server 3 based on selection of the smartphone settlement button BJ on the settlement selection screen SCE (ACT 36). The online settlement start instruction is an instruction to start an online settlement of a transaction performed using the terminal 4. The online settlement start instruction may include identification information concerning the transaction X such as a shopping member ID, an electronic receipt member ID, or a first transaction ID.

The online settlement server 3 acquires the online settlement start instruction from the terminal 4 (ACT 37). The online settlement server 3 may acquire amount information of the transaction X from the transaction management server 1 based on the first transaction ID included in the online settlement start instruction. The online settlement server 3 may acquire amount information of the transaction X correlated with the online settlement start instruction from the terminal 4. The online settlement server 3 communicates with a settlement center corresponding to the terminal 4 and a settlement method selected by the user and processes, for an amount indicated by the amount information, the online settlement of the transaction performed using the terminal 4 (ACT 38). The online settlement server 3 outputs an online settlement completion notification to the terminal 4 based on completion of the online settlement of the transaction performed using the terminal 4 (ACT 39). The online settlement completion notification indicates completion of the online settlement of the transaction performed using the terminal 4.

The terminal 4 acquires the online settlement completion notification from the online settlement server 3 (ACT 40). The user ends the shopping performed using the shopping application according to the completion of the settlement of the transaction.

The communication processing unit 102 of the transaction management server 1 outputs an inquiry about a settlement status of the transaction to the online settlement server 3 (ACT 41). In ACT 41, the communication processing unit 102 repeatedly outputs the inquiry about the settlement status of the transaction to the online settlement server 3 at a constant interval. The settlement status of the transaction is a status of the online settlement of the transaction performed using the terminal 4. The inquiry of the settlement status includes a request for the settlement status. The inquiry about the settlement status may include identification information concerning the transaction X such as a shopping member ID, an electronic receipt member ID, or a first transaction ID.

The online settlement server 3 acquires the inquiry about the settlement status of the transaction from the transaction management server 1 (ACT 42).

The online settlement server 3 outputs the settlement status of the transaction to the transaction management server 1 as a response to the inquiry about the settlement status of the transaction (ACT 43). Before completion of the online settlement of the transaction performed using the terminal 4, the online settlement server 3 outputs a notification indicating unsettlement of the transaction to the transaction management server 1 as the settlement status of the transaction. After the completion of the online settlement of the transaction performed using the terminal 4, the online settlement server 3 outputs a notification indicating completion of the settlement of the transaction to the transaction management server 1 as the settlement status of the transaction. The notification may include identification concerning the transaction X such as a shopping member ID, an electronic receipt member ID, or a first transaction ID.

The communication processing unit 102 of the transaction management server 1 acquires the settlement status of the transaction from the online settlement server 3 (ACT 44). In ACT 44, for example, before the completion of the online settlement of the transaction performed using the terminal 4, the communication processing unit 102 acquires notification including unsettlement of the transaction from the online settlement server 3 as the settlement status of the transaction. After the completion of the online settlement of the transaction performed using the terminal 4, the communication processing unit 102 acquires notification including completion of the settlement of the transaction from the online settlement server 3 as the settlement status of the transaction.

When the settlement status of the transaction is the completion of the settlement of the transaction, the communication processing unit 102 outputs transaction data, a first transaction ID, and an electronic receipt member ID concerning the transaction X to the electronic receipt server 2 (ACT 45). In ACT 45, for example, the communication processing unit 102 refers to identification information concerning the transaction X included in the notification acquired from the online settlement server 3. The communication processing unit 102 outputs the transaction data, the first transaction ID, and the electronic receipt member ID concerning the transaction X stored in the transaction data storage region 122 to the electronic receipt server 2. The transaction data, the first transaction ID, and the electronic receipt member ID concerning the transaction X are the transaction data concerning the transaction X, the first transaction ID concerning the transaction X, and the electronic receipt member ID concerning the transaction X associated with one another.

The communication processing unit 202 of the electronic receipt server 2 acquires the transaction data, the first transaction ID, and the electronic receipt member ID concerning the transaction X from the transaction management server 1 (ACT 46). The storage control unit 203 stores the transaction data, the first transaction ID, and the electronic receipt member ID acquired from the transaction management server 1 in the electronic receipt storage region 222 (ACT 47). The processor 20 generates electronic receipt data based on the transaction data. The electronic receipt data includes the first transaction ID concerning the transaction X. The processor 20 stores the generated electronic receipt data in the electronic receipt storage region 222 in association with the first transaction ID concerning the transaction X. Consequently, the electronic receipt storage region 222 stores, concerning the transaction X, the electronic receipt member ID, the first transaction ID, the transaction data, and the electronic receipt data.

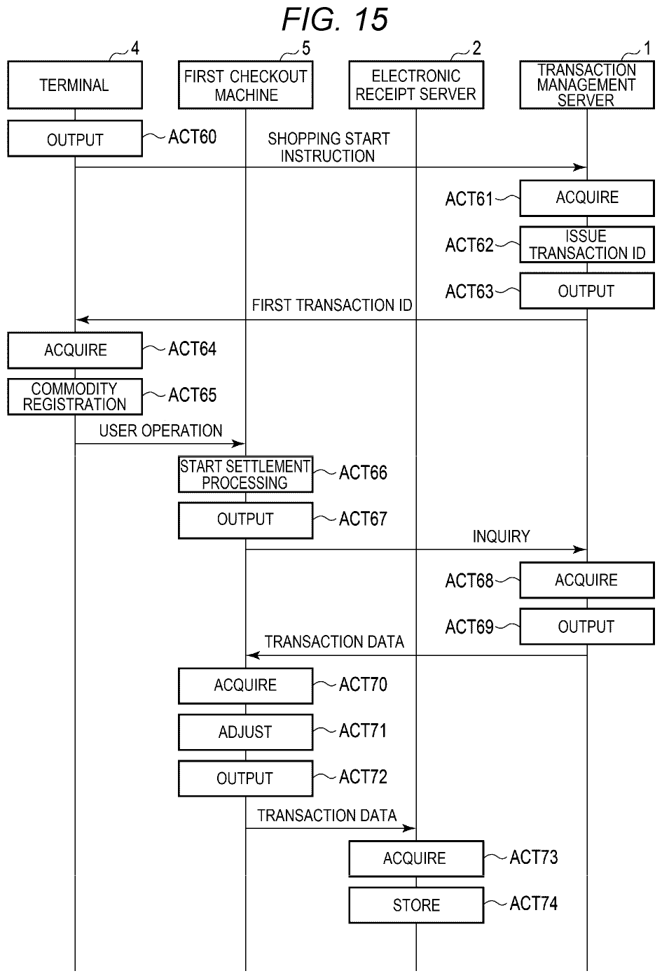

FIG. 14 is a sequence chart illustrating an example of commodity return processing in the information processing system SY.

Here, commodity return processing in the first checkout machine 5 relating to a first example is explained. The first checkout machine 5 is an example of a device that processes commodity return in a transaction. A settlement-completed transaction X is set as a commodity return target. It is assumed that the user causes, using the electronic receipt service, the terminal 4 to display an electronic receipt including a first transaction ID concerning the settlement-completed transaction X set as the commodity return target.

The commodity return processing unit 503 of the first checkout machine 5 receives input of the first transaction ID concerning the transaction X (ACT 50). In ACT 50, for example, the commodity return processing unit 503 may receive, based on reading of a code symbol displayed on the terminal 4 by the scanner 55, input of the first transaction ID acquired from the code symbol. The commodity return processing unit 503 may receive the input of the first transaction ID based on input operation for the first transaction ID performed using the input device 58. The communication processing unit 501 outputs, based on the input of the first transaction ID, an inquiry about transaction data associated with the first transaction ID concerning the transaction X to the transaction management server 1 (ACT 51). The inquiry about the transaction data includes a request for transaction data. The inquiry about the transaction data includes the first transaction ID concerning the transaction X.

The communication processing unit 102 of the transaction management server 1 acquires the inquiry about the transaction data from the first checkout machine 5 (ACT 52). The communication processing unit 102 outputs, as a response to the inquiry about the transaction data, the transaction data, the first transaction ID, and the electronic receipt member ID concerning the transaction X associated with the first transaction ID concerning the transaction X to the first checkout machine 5 (ACT 53).

The communication processing unit 501 of the first checkout machine 5 acquires the transaction data, the first transaction ID, and the electronic receipt member ID concerning the transaction X from the transaction management server 1 (ACT 54). The storage control unit 504 stores the transaction data, the first transaction ID, and the electronic receipt member ID concerning the transaction X in the auxiliary storage device 52 (ACT 55). The commodity return processing unit 503 processes commodity return in the transaction X based on the transaction data concerning the transaction X (ACT 56). In ACT 56, for example, the commodity return processing unit 503 generates commodity return information concerning the commodity return based on the commodity return processing. The commodity return information includes information concerning a returned commodity. For example, the information concerning the returned commodity includes a commodity ID and the number of items of the returned commodity. The commodity return information includes the first transaction ID concerning the transaction X. The communication processing unit 501 outputs the commodity return information to the electronic receipt server 2 based on the commodity return processing by the commodity return processing unit 503 (ACT 57).

The communication processing unit 202 of the electronic receipt server 2 acquires the commodity return information from the first checkout machine 5 (ACT 58). The storage control unit 203 updates the transaction data concerning the transaction X based on the commodity return information (ACT 59). In ACT 59, for example, the storage control unit 203 retrieves, in the electronic receipt storage region 222, transaction data concerning the transaction X associated with the first transaction ID concerning the transaction X included in the commodity return information. The storage control unit 203 reflects, on the retrieved transaction data concerning the transaction X, the information concerning the returned commodity included in the commodity return information. The storage control unit 203 updates the transaction data concerning the transaction X based on the reflection. The processor 20 updates the electronic receipt data concerning the transaction X based on the updated transaction data concerning the transaction X.

Note that, in ACT 51, the communication processing unit 501 of the first checkout machine 5 outputs the inquiry to the transaction management server 1 based on the input of the first transaction ID. However, not only this, but the communication processing unit 501 may periodically output the inquiry to the transaction management server 1 without requiring the input of the first transaction ID. In this example, the inquiry is inquiry of transaction data not specifying a settlement-competed transaction. The communication processing unit 501 acquires, for each of transactions, an electronic receipt member ID, a first transaction ID, and transaction data from the transaction management server 1. The storage control unit 504 stores, for each of transactions, the electronic receipt member ID, the first transaction ID, and the transaction data in the auxiliary storage device 52. Consequently, the auxiliary storage device 52 stores, for each of transactions, the electronic receipt member ID, the first transaction ID, and the transaction data. The electronic receipt member ID, the first transaction ID, and the transaction data are associated with one another.

According to the first example, if the settlement status about the online settlement of the transaction X performed using the terminal 4 is the completion of the settlement of the transaction X, the transaction management server 1 outputs the transaction data concerning the transaction X to the electronic receipt server 2. Consequently, even if the user performs the online settlement of the transaction X performed using the terminal 4, the transaction management server 1 is capable of linking the transaction data concerning the transaction X with the electronic receipt server 2.

The transaction management server 1 acquires the settlement status of the transaction from the online settlement server 3. Consequently, the transaction management server 1 can check the completion of the settlement of the transaction X even if the user performs the online settlement of the transaction X performed using the terminal 4. Therefore, the transaction management server 1 is capable of linking the transaction data concerning the settlement-completed transaction X with the electronic receipt server 2.

The transaction management server 1 repeatedly outputs the inquiry about the settlement status of the transaction to the online settlement server 3. Consequently, the transaction management server 1 can check the completion of the settlement of the transaction X.

The transaction management server 1 outputs a first transaction ID of a code scheme usable in the first checkout machine 5 to the electronic receipt server 2. Consequently, the transaction management server 1 can cause the electronic receipt server 2 to manage the transaction data in association with the first transaction ID usable in the first checkout machine 5. The electronic receipt server 2 can enable an electronic receipt including a first transaction ID concerning a settlement-completed transaction set as a commodity return target to be viewed in the terminal 4. Therefore, the first checkout machine 5 can process commodity return performed using the first transaction ID. The first checkout machine 5 can update, based on the commodity return processing, the transaction data associated with the first transaction ID stored in the electronic receipt server 2. The user can view the electronic receipt updated based on the update of the transaction data.

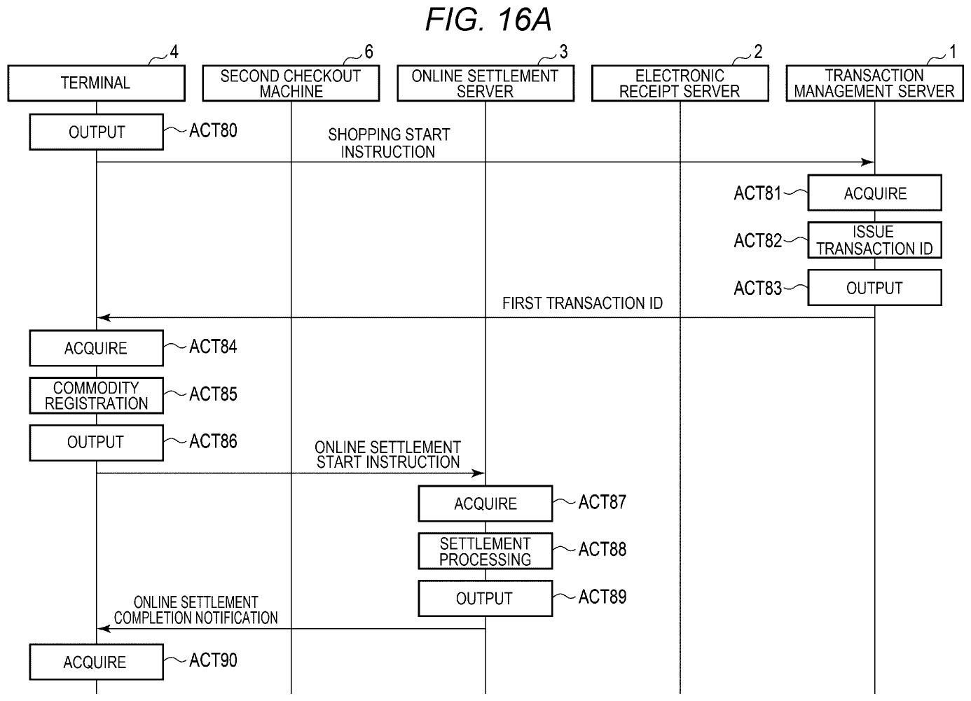

FIG. 15 is a sequence chart illustrating a second example of linkage processing for associating transaction data with the electronic receipt server 2 in the information processing system SY.

The second example is an example in which the first checkout machine 5 links the transaction data stored in the transaction management server 1 with the electronic receipt server 2.

Processing in ACT 60 to ACT 65 is the same as the processing in ACT 30 to ACT 35 explained above. Therefore, additional explanation of the processing is omitted. After ending the commodity registration performed using the terminal 4, the user performs a settlement of the transaction. It is assumed here that the settlement method for the transaction is a settlement performed using the first checkout machine 5. The user selects the checkout machine settlement button BK on the settlement selection screen SCE.

The settlement processing unit 502 of the first checkout machine 5 starts settlement processing for the transaction based on user operation performed using the input device 58 (ACT 66). In ACT 66, for example, the settlement processing unit 502 acquires a first transaction ID concerning the transaction X based on reading of a code symbol displayed on the terminal 4 by the scanner 55. The communication processing unit 501 outputs, based on a start of the settlement of the transaction X by the settlement processing unit 502, an inquiry about transaction data associated with the first transaction ID concerning the transaction X included in the code symbol to the transaction management server 1 (ACT 67). The inquiry about the transaction data includes the first transaction ID concerning the transaction X.

The communication processing unit 102 of the transaction management server 1 acquires the inquiry about the transaction data from the first checkout machine 5 (ACT 68). The communication processing unit 102 outputs the transaction data, the first transaction ID, and the electronic receipt member ID concerning the transaction X to the first checkout machine 5 as a response to the inquiry about the transaction data (ACT 69).

The communication processing unit 501 of the first checkout machine 5 acquires the transaction data, the first transaction ID, and the electronic receipt member ID concerning the transaction X from the transaction management server 1 based on the start of the settlement of the transaction X by the settlement processing unit 502 (ACT 70). The settlement processing unit 502 adjusts, based on operation of the input and output interface 54 by the user, a price through a settlement of the transaction X corresponding to the acquired transaction data concerning the transaction X (ACT 71). The first checkout machine 5 only has to be used for the settlement of the transaction X. The settlement of the transaction X may be an online settlement or may be an offline settlement by cash. The communication processing unit 501 outputs, based on completion of the settlement of the transaction X by the settlement processing unit 502, the transaction data, the first transaction ID, and the electronic receipt member ID concerning the transaction X acquired from the transaction management server 1 to the electronic receipt server 2 (ACT 72).

The communication processing unit 202 of the electronic receipt server 2 acquires the transaction data, the first transaction ID, and the electronic receipt member ID concerning the transaction X from the first checkout machine 5 (ACT 73). The storage control unit 203 stores the transaction data, the first transaction ID, and the electronic receipt member ID acquired from the first checkout machine 5 in the electronic receipt storage region 222 (ACT 74). The processor 20 generates electronic receipt data based on the transaction data. The electronic receipt data includes the first transaction ID concerning the transaction X. The processor 20 stores the generated electronic receipt data in the electronic receipt storage region 222 in association with the first transaction ID concerning the transaction X. Consequently, the electronic receipt storage region 222 stores the electronic receipt member ID, the first transaction ID, the transaction data, and the electronic receipt data related to the transaction X.

Commodity return processing in the first checkout machine 5 relating to the second example is the same as the commodity return processing in the first checkout machine 5 relating to the first example explained with reference to FIG. 14. Therefore, explanation of the commodity return processing is omitted.

According to the second example, the first checkout machine 5 acquires the transaction data concerning the transaction X from the transaction management server 1 based on the start of the settlement of the transaction X and outputs the acquired transaction data concerning the transaction X to the electronic receipt server 2 based on the completion of the settlement of the transaction X. Consequently, even if the user performs the settlement of the transaction X using the first checkout machine 5, the first checkout machine 5 is capable of linking the transaction data concerning the transaction X with the electronic receipt server 2.

The first checkout machine 5 acquires the first transaction ID for the transaction X from the transaction management server 1 and outputs the acquired first transaction ID to the electronic receipt server 2. Consequently, when outputting the transaction data to the electronic receipt server 2, the first checkout machine 5 does not need to issue a transaction ID different from the first transaction ID anew. Therefore, a processing load of the first checkout machine 5 is reduced.

The first checkout machine 5 outputs the first transaction ID in the code scheme usable in the first checkout machine 5 to the electronic receipt server 2. Consequently, the first checkout machine 5 can cause the electronic receipt server 2 to manage the transaction data linked to a first transaction ID usable in the first checkout machine 5. The electronic receipt server 2 can enable an electronic receipt including the first transaction ID for a settlement-completed transaction set as a commodity return target to be viewed in the terminal 4. Therefore, the first checkout machine 5 can process commodity returns when the commodity was settled using the first transaction ID. The first checkout machine 5 can update, based on the commodity return processing, the transaction data associated with the first transaction ID stored in the electronic receipt server 2. The user can view the electronic receipt updated based on the updated transaction data.

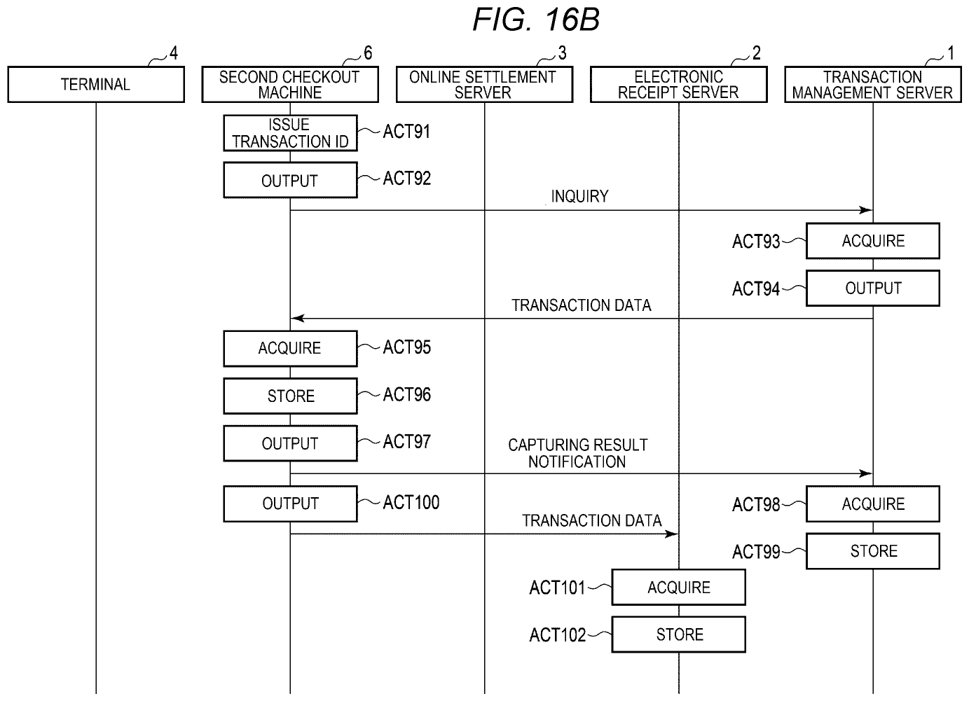

FIG. 16A and FIG. 16B are sequence charts illustrating a third example of linkage processing for associating transaction data with the electronic receipt server 2 in the information processing system SY.

The third example is an example in which the second checkout machine 6 links the transaction data stored in the transaction management server 1 with the electronic receipt server 2.

Processing in ACT 80 to ACT 90 is the same as the processing in ACT 30 to ACT 40 explained above. Therefore, additional explanation of the processing is omitted.

The issuing unit 605 of the second checkout machine 6 issues a second transaction ID (ACT 91). The communication processing unit 601 repeatedly outputs an inquiry about transaction data to the transaction management server 1 (ACT 92). The inquiry about the transaction data is an inquiry about transaction data not specifying a settlement-completed transaction.

The communication processing unit 102 of the transaction management server 1 acquires the inquiry about the transaction data from the second checkout machine 6 (ACT 93). The communication processing unit 102 outputs, as a response to the inquiry about the transaction data, transaction data, a first transaction ID, and an electronic receipt member ID associated with specific settlement status information to the second checkout machine 6 (ACT 94). The specific settlement status information is settlement status information indicating completion of a settlement of a transaction and including information indicating an online settlement of the transaction performed using the terminal 4 as a settlement method for the transaction. Here, it is assumed that the communication processing unit 102 outputs transaction data, a first transaction ID, and an electronic receipt member ID concerning the transaction X to the second checkout machine 6. Here, settlement status information associated with the transaction X indicates the completion of the settlement of the transaction as explained above. Therefore, the communication processing unit 102 outputs the transaction data, the first transaction ID, and the electronic receipt member ID concerning the transaction X to the second checkout machine 6 after completion of an online settlement of the transaction X performed using the terminal 4.

The communication processing unit 601 of the second checkout machine 6 acquires the transaction data, the first transaction ID, and the electronic receipt member ID concerning the transaction X from the transaction management server 1 after completion of the online settlement of the transaction X performed using the terminal 4 (ACT 95).

The storage control unit 604 stores the second transaction ID issued by the issuing unit 605 in the auxiliary storage device 62 in association with the transaction data, the first transaction ID, and the electronic receipt member ID concerning the transaction X. The second transaction ID associated with the first transaction ID concerning the transaction X is considered to be a transaction ID concerning the transaction X. Consequently, the auxiliary storage device 62 stores, for each of transactions, an electronic receipt member ID, a first transaction ID, a second transaction ID, and transaction data. For example, the auxiliary storage device 62 stores, concerning the transaction X, an electronic receipt member ID, a first transaction ID, a second transaction ID, and transaction data. The electronic receipt member ID, the first transaction ID, the second transaction ID, and the transaction data are associated with one another. The communication processing unit 601 outputs capturing result notification to the transaction management server 1 (ACT 97). The capturing result notification is notification indicating that the second checkout machine 6 has normally stored the transaction data. The capturing result notification may include the first transaction ID concerning the transaction X and the second transaction ID concerning the transaction X associated with each other.

The communication processing unit 102 of the transaction management server 1 acquires the capturing result notification from the second checkout machine 6 (ACT 98). If the capturing result notification includes the first transaction ID concerning the transaction X and the second transaction ID concerning the transaction X, the storage control unit 104 stores the first transaction ID concerning the transaction X and the second transaction ID concerning the transaction X in the transaction data storage region 122 in association with each other. Consequently, the transaction data storage region 122 stores, for each of transactions, the first transaction ID, the second transaction ID, the shopping member ID, the electronic receipt member ID, the transaction data, and the settlement status information. For example, the transaction data storage region 122 stores, concerning the transaction X, the first transaction ID, the second transaction ID, the shopping member ID, the electronic receipt member ID, the transaction data, and the settlement status information.

The communication processing unit 601 of the second checkout machine 6 outputs the transaction data, the second transaction ID, and the electronic receipt member ID concerning the transaction X to the electronic receipt server 2 (ACT 100). The transaction data, the second transaction ID, and the electronic receipt member ID concerning the transaction X are the transaction data concerning the transaction X, the second transaction ID concerning the transaction X, and the electronic receipt member ID concerning the transaction X associated with one another.

The communication processing unit 202 of the electronic receipt server 2 acquires the transaction data, the second transaction ID, and the electronic receipt member ID concerning the transaction X from the second checkout machine 6 (ACT 101). The storage control unit 203 stores the transaction data, the second transaction ID, and the electronic receipt member ID acquired from the second checkout machine 6 in the electronic receipt storage region 222 (ACT 102). The processor 20 generates electronic receipt data based on the transaction data. The electronic receipt data includes the second transaction ID concerning the transaction X. The processor 20 stores the generated electronic receipt data in the electronic receipt storage region 222 in association with the second transaction ID concerning the transaction X. Consequently, the electronic receipt storage region 222 stores, concerning the transaction X, the electronic receipt member ID, the second transaction ID, the transaction data, and the electronic receipt data.

Note that, in ACT 91, the issuing unit 605 of the second checkout machine 6 issues the second transaction ID before the processing in ACT 95 by the communication processing unit 601. However, issuing timing is not limited to this. The issuing unit 605 may issue the second transaction ID after checking completion of online settlement of a new transaction X performed using the terminal 4. That is, the issuing unit 605 may issue the second transaction ID after the processing in ACT 95 by the communication processing unit 601.

Note that, in ACT 94, the communication processing unit 102 of the transaction management server 1 outputs the data to the second checkout machine 6 as the response to the inquiry about the transaction data. However, not only this, but, if settlement status information concerning any transaction is updated to specific settlement status information, the communication processing unit 102 may autonomously output data associated with the specific settlement status information to the second checkout machine 6.

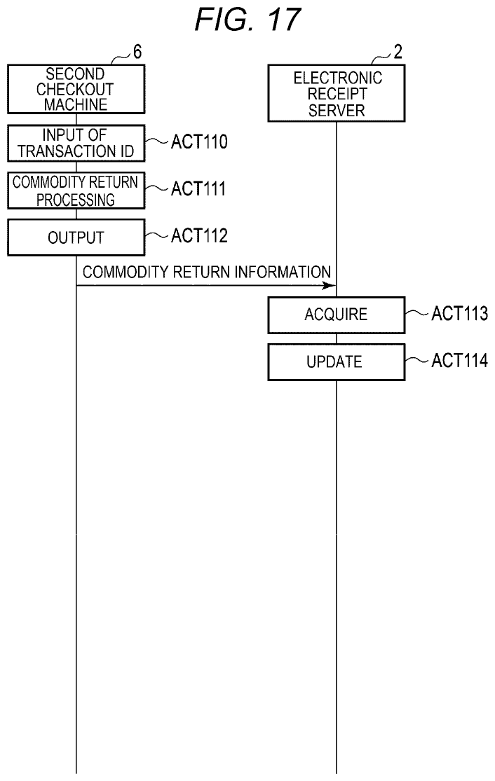

FIG. 17 is a sequence chart illustrating another example of the commodity return processing in the information processing system SY.

Here, commodity return processing in the second checkout machine 6 relating to a third example is explained. The second checkout machine 6 is an example of a device that processes commodity return in a transaction. A settlement-completed transaction X is set as a commodity return target. It is assumed that the user causes, using the electronic receipt service, the terminal 4 to display an electronic receipt including a second transaction ID concerning the settlement-completed transaction X set as the commodity return target.

The commodity return processing unit 603 of the second checkout machine 6 receives input of the second transaction ID concerning the transaction X (ACT 110). In ACT 110, for example, the commodity return processing unit 603 may receive, based on reading of a code symbol displayed on the terminal 4 by the scanner 65, input of a second transaction ID acquired from the code symbol. The commodity return processing unit 603 may receive the input of the second transaction ID based on input operation for the second transaction ID performed using the input device 68.

The commodity return processing unit 603 processes commodity return in the transaction X based on transaction data concerning the transaction X identified by the second transaction ID stored in the auxiliary storage device 62 (ACT 111). In ACT 111, for example, the commodity return processing unit 603 generates commodity return information based on the commodity return processing. The commodity return information includes the second transaction ID concerning the transaction X. The communication processing unit 601 outputs the commodity return information to the electronic receipt server 2 based on the commodity return processing by the commodity return processing unit 603 (ACT 112).

The communication processing unit 202 of the electronic receipt server 2 acquires the commodity return information from the second checkout machine 6 (ACT 113). The storage control unit 203 updates the transaction data concerning the transaction X based on the commodity return information (ACT 114). In ACT 114, for example, the storage control unit 203 retrieves, in the electronic receipt storage region 222, transaction data concerning the transaction X associated with the second transaction ID concerning the transaction X included in the commodity return information. The storage control unit 203 reflects, on the retrieved transaction data concerning the transaction X, the information concerning the returned commodity included in the commodity return information. The storage control unit 203 updates the transaction data concerning the transaction X based on the reflection. The processor 20 updates the electronic receipt data concerning the transaction X based on the updated transaction data concerning the transaction X.

Note that, in ACT 111, the commodity return processing unit 603 processes the commodity return in the transaction X based on the transaction data stored in the auxiliary storage device 62. However, not only this, but the commodity return processing unit 603 may process the commodity return in the transaction X based on the transaction data stored in the auxiliary storage device 12 of the transaction management server 1.

According to the third example, the second checkout machine 6 outputs the transaction data acquired from the transaction management server 1 and the issued second transaction ID to the electronic receipt server 2 after the completion of the online settlement of the transaction X performed using the terminal 4. Consequently, even if the user performs the online settlement of the transaction X performed using the terminal 4, the second checkout machine 6 is capable of linking the transaction data concerning the transaction X with the electronic receipt server 2. Further, even if the first transaction ID issued by the transaction management server 1 is an ID of a system that cannot be used in the second checkout machine 6, the second checkout machine 6 can cause the electronic receipt server 2 to manage transaction data in association with a second transaction ID usable in the second checkout machine 6. The electronic receipt server 2 can enable an electronic receipt including a second transaction ID concerning a settlement-completed transaction set as a commodity return target to be viewed in the terminal 4. Therefore, the second checkout machine 6 can process commodity return performed using the second transaction ID.

The second checkout machine 6 repeatedly outputs the inquiry about the transaction data to the transaction management server 1. Consequently, even if the user performs the online settlement of the transaction X performed using the terminal 4, the second checkout machine 6 can acquire transaction data concerning a settlement-completed transaction from the transaction settlement server 1. Therefore, the second checkout machine 6 is capable of linking the transaction data concerning the settlement-completed transaction with the electronic receipt server 2.

The transaction management server 1 repeatedly outputs the inquiry about the settlement status of the transaction to the online settlement server 3. Consequently, the transaction management server 1 can check the completion of the settlement of the transaction X.

The second checkout machine 6 processes the commodity return in the transaction X identified by the second transaction ID based on the input of the second transaction ID and outputs the commodity return information including the second transaction ID to the electronic receipt server 2. Consequently, the second checkout machine 6 can update, based on the commodity return processing, the transaction data associated with the second transaction ID stored in the electronic receipt server 2. The user can view an electronic receipt updated based on the update of the transaction data.

The first transaction ID associated with the transaction data stored in the transaction management server 1 is a code scheme not usable in the second checkout machine 6. Consequently, the second checkout machine 6 can cause the electronic receipt server 2 to manage the transaction data in association with the second transaction ID usable in the second checkout machine 6 rather than the first transaction ID. Therefore, the second checkout machine 6 can process commodity return performed using the second transaction ID usable in the second checkout machine 6.

### Effects

According to the embodiments described above, the transaction management server 1, the first checkout machine 5, or the second checkout machine 6 is capable of linking transaction data concerning a settlement-completed transaction with the electronic receipt server 2 irrespective of a settlement method for a transaction.

The embodiments explained above may be represented as follows.

[A1] A transaction management server 1 including:
a storage unit that stores transaction data concerning a transaction based on commodity registration performed using a terminal by a user;
an acquiring unit that acquires a status of an online settlement of the transaction performed using the terminal; and
an output unit that outputs the transaction data to an electronic receipt server 2 if the status is completion of the settlement of the transaction.

[A2] The transaction management server 1 described in [A1], wherein the acquiring unit acquires the status from an online settlement server 3 with which the terminal communicates for the online settlement.

[A3] The transaction management server 1 described in [A1] or [A2], wherein the output unit repeatedly outputs an inquiry about the status to the online settlement server 3.

[A4] The transaction management server 1 described in any one of [A1] to [A3], wherein
a transaction code concerning the transaction is a code scheme usable in a device that processes commodity return in the transaction, and
the output unit outputs the transaction code to the electronic receipt server 2.

[A5] A program capable of causing a processor of a transaction management server 1, which stores transaction data concerning a transaction based on commodity registration performed using a terminal by a user, to execute:
a function of acquiring a status of an online settlement of the transaction performed using the terminal; and
a function of outputting the transaction data to an electronic receipt server 2 if the status is completion of the settlement of the transaction.

[B1] A checkout machine 5 or 6 including:
a settlement processing unit that processes a settlement of a transaction based on commodity registration performed using a terminal by a user;
an acquiring unit that acquires, based on a start of the settlement of the transaction, a transaction data concerning the transaction from a transaction management server 1 that stores the transaction data; and
an output unit that outputs the transaction data to an electronic receipt server 2 based on completion of the settlement of the transaction.

[B2] The checkout machine 5 or 6 described in [B1], wherein
the acquiring unit acquires a transaction code concerning the transaction from the transaction management server 1, and
the output unit outputs the transaction code to the electronic receipt server 2.

[B3] The checkout machine 5 or 6 described in [B1] or [B2], wherein the transaction code is a code scheme usable in the checkout machine 5 or 6.

[B4] A program capable of causing a computer to execute:
a function of processing a settlement of a transaction based on commodity registration performed using a terminal by a user;
a function of acquiring, based on a start of the settlement of the transaction, transaction data concerning the transaction from a transaction management server 1 that stores the transaction data; and
a function of outputting the transaction data to an electronic receipt server 2 based on completion of the settlement of the transaction.

[C1] An information processing device including:
an acquiring unit that acquires, after completion of an online settlement of a transaction based on commodity registration performed using a terminal by a user, from a transaction management server 1 that stores transaction data concerning the transaction and a first transaction code concerning the transaction, the transaction data and the first transaction code;
an issuing unit that issues a second transaction code of a code scheme different from the first transaction code; and
an output unit that outputs the transaction data and the second transaction code to an electronic receipt server 2.

[C2] The information processing device described in [C1], wherein the online settlement is a settlement not via a checkout machine 5 or 6 based on communication between the terminal and an online settlement server 3.

[C3] The information processing device described in [C1] or [C2], wherein the first transaction code is a code scheme not usable in the information processing device.

[C4] The information processing device described in any one of [C1] to [C3], wherein the second transaction code is a code scheme having a smaller number of digits than the first transaction code.

[C5] The information processing device described in any one of [C1] to [C4], wherein the output unit repeatedly outputs an inquiry about transaction data to the transaction management server 1.

[C6] The information processing device described in any one of [C1] to [C5], further including a commodity return processing unit that processes commodity return in the transaction based on input of the second transaction code, wherein
the output unit outputs information concerning the commodity return including the second transaction code to the electronic receipt server 2.

[C7] A program for causing a computer to execute:
a function of acquiring, after completion of an online settlement of a transaction based on commodity registration performed using a terminal by a user, from a transaction management server 1 that stores transaction data concerning the transaction and a first transaction code concerning the transaction, the transaction data and the first transaction code;
a function of issuing a second transaction code of a code scheme different from the first transaction code; and
a function of outputting the transaction data and the second transaction code to an electronic receipt server 2.

### Other Embodiments

The transaction management server 1 may be implemented by one device or may be implemented by a plurality of devices to which functions are distributed. The checkout machine 5 or 6 may be implemented by one device or may be implemented by a plurality of devices to which functions are distributed. The information processing device may be implemented by one device or may be implemented by a plurality of devices to which functions are distributed.

The embodiments explained above may be applied to not only a device but also a method executed by the device. The embodiments may be applied to a program capable of causing a computer of the device to execute the functions. The embodiments explained above may be applied to a recording medium storing the program.

The program may be transferred in a state in which the program is stored in a device according to an embodiment or may be transferred in a state in which the program is not stored in such a device. In the latter case, the program may be transferred via a network or may be transferred in a state in which the program is recorded in a recording medium. The recording medium is a non-transitory tangible medium. The recording medium is a computer-readable medium. The recording medium only has to be a medium capable of storing a program and readable by a computer such as a CD-ROM or a memory card. A form of the recording medium does not matter.

Several embodiments of the present disclosure are explained above. However, these embodiments are presented as examples and are not intended to limit the scope of the disclosure. New embodiments can be implemented in other various forms. Various omissions, substitutions, and changes can be made in a range not departing from the gist of the disclosure. These embodiments and modifications thereof are included in the scope and the gist of the disclosure and included in the disclosure described in the claims and a scope of equivalents of the disclosure.

What is claimed is:

1. A checkout machine in a store for performing a checkout process in a sales transaction, the checkout machine comprising:
a network interface connectable to a transaction management server for managing a sales transaction in which a checkout process is performed with or without a checkout machine in the store and an electronic receipt server for managing an electronic receipt of the sales transaction; and
a processor configured to:
acquire, from the transaction management server, data of a sales transaction in which a checkout process is performed without any checkout machine in the store, and a first transaction code of the sales transaction, the first transaction code being issued by the transaction management server according to a first code scheme,
issue a second transaction code according to a second code scheme that is different from the first code scheme, and
control the network interface to transmit the data of the sales transaction and the second transaction code to the electronic receipt server.

2. The checkout machine according to claim 1, wherein the checkout process of the sales transaction having the first transaction code is performed online.

3. The checkout machine according to claim 1, wherein the processor is configured to control the network interface to transmit the second transaction code to the transaction management server in association with the first transaction code.

4. The checkout machine according to claim 1, wherein the second transaction code has smaller digits than the first transaction code.

5. The checkout machine according to claim 1, further comprising:
an input device, wherein
the processor is configured to:
upon an input of the second transaction code, execute commodity return processing on one or more commodities purchased in the sales transaction associated with the second transaction code, and
control the network interface to transmit information concerning the commodity return processing to the electronic receipt server in association with the second transaction code.

6. The checkout machine according to claim 1, wherein the processor is configured to control the network interface to repeatedly transmit to the transaction management server an inquiry for a sales transaction without including any transaction code.

7. The checkout machine according to claim 1, wherein the processor is configured to:
acquire an electronic receipt user ID from the transaction management server in association with the first transaction code, and
control the network interface to transmit to the electronic receipt server the electronic receipt user ID in association with the second transaction code.

8. A method performed by a checkout machine in a store for performing a checkout process in a sales transaction, the method comprising:
connecting to a transaction management server for managing a sales transaction in which a checkout process is performed with or without a checkout machine in the store;
acquiring, from the transaction management server, data of a sales transaction in which a checkout process is performed without any checkout machine in the store, and a first transaction code of the sales transaction, the first transaction code being issued by the transaction management server according to a first code scheme;
issuing a second transaction code according to a second code scheme that is different from the first code scheme; and
transmitting the data of the sales transaction and the second transaction code to an electronic receipt server for managing an electronic receipt of the sales transaction.

9. The method according to claim 8, wherein the checkout process of the sales transaction having the first transaction code is performed online.

10. The method according to claim 8, further comprising:
transmitting the second transaction code to the transaction management server in association with the first transaction code.

11. The method according to claim 8, wherein the second transaction code has smaller digits than the first transaction code.

12. The method according to claim 8, further comprising:
upon an input of the second transaction code, executing commodity return processing on one or more commodities purchased in the sales transaction associated with the second transaction code; and
transmitting information concerning the commodity return processing to the electronic receipt server in association with the second transaction code.

13. The method according to claim 8, further comprising:
repeatedly transmitting to the transaction management server an inquiry for a sales transaction without including any transaction code.

14. The method according to claim 8, further comprising:
acquiring an electronic receipt user ID from the transaction management server in association with the first transaction code; and
transmitting to the electronic receipt server the electronic receipt user ID in association with the second transaction code.

15. A system for managing a sales transaction performed in a store, the system comprising:
a transaction management server configured to manage a sales transaction in which a checkout process is performed with or without a checkout machine in the store; and
an information processing device configured to:
acquire, from the transaction management server, data of a sales transaction in which a checkout process is performed without any checkout machine in the store, and a first transaction code of the sales transaction, the first transaction code being issued by the transaction management server according to a first code scheme,
issue a second transaction code according to a second code scheme that is different from the first code scheme, and
transmit the data of the sales transaction and the second transaction code to an electronic receipt server for managing an electronic receipt of the sales transaction.

16. The system according to claim 15, further comprising:
a terminal configured to perform the checkout process in the sales transaction having the first transaction code in communication with an online settlement server.

17. The system according to claim 15, wherein the information processing device is configured to transmit the second transaction code to the transaction management server in association with the first transaction code.

18. The system according to claim 15, wherein the second transaction code has smaller digits than the first transaction code.

19. The system according to claim 15, wherein the information processing device is configured to:
upon an input of the second transaction code, execute commodity return processing on one or more commodities purchased in the sales transaction associated with the second transaction code, and
transmit information concerning the commodity return processing to the electronic receipt server in association with the second transaction code.

20. The system according to claim 15, wherein the information processing device is configured to repeatedly transmit to the transaction management server an inquiry for a sales transaction without including any transaction code.
